(19) United States
(12) Patent Application Publication
(10) Pub. No.: US 2009/0295024 A1
(43) Pub. Date: Dec. 3, 2009

(54) NANOIMPRINT MOLD

(76) Inventors: Junji Watanabe, Tokyo (JP); Suzushi Nishimura, Yokohama-shi (JP); Takashi Seki, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/436,176

(22) Filed: May 6, 2009

(30) Foreign Application Priority Data
May 29, 2008 (JP) P2008-141666

(51) Int. Cl. B29C 59/02; B29C 33/42

(52) U.S. Cl. 264/227; 264/293; 425/112

(57) ABSTRACT

The nanoimprint mold of the invention comprises a liquid crystal substance and has an indentation surface on which a relief structure is formed by orientation of the liquid crystal substance. The nanoimprint mold can be easily produced without providing joints, even when the area of the transfer indentation surface is large.

### BACKGROUND OF THE INVENTION

1. Field of the Invention

The present invention relates to a nanoimprint mold, to a process for its production, and to a method of working materials using the nanoimprint mold.

2. Related Background Art

In production steps for semiconductor integrated circuits it is necessary to form extremely fine patterns with line widths of between 100 and a few tens of nm. Field-effect transistors having gate line widths of 45 nm have recently come to be produced in mass, and development is progressing towards industrial realization of gate line widths of 32 nm or smaller.

Optical lithography methods have conventionally been employed for formation of such extra fine patterns. In optical lithography, a KrF excimer laser (krypton fluoride, 248 nm) or ArF excimer laser (argon fluoride, 193 nm) is used as the light source. The light source wavelength must be shortened for increased micronization, but it is difficult to achieve shorter light source wavelengths than currently available.

Nanoimprinting has attracted interest as a technique for surpassing the limits of optical lithography. Nanoimprinting is a micromachining technique that has undergone notable development in recent years based on the nanoimprint lithography technology proposed in 1995 by Professor Chou of University of Minnesota, U.S.A. (Hirai Y., “Nanoimprinting: Fundamentals and Technological Development and Applications, Frontier Publishing, Jul. 7, 2006, ISBN4-902410-09-5 C3054).

Nanoimprinting is a method of working in which a mold is prepared having an indentation surface formed by a required line width pattern, and the indentation surface pattern is transferred to a desired material surface to produce a replica thereof. Materials used for the replica include glass, plastic and the like. Nanoimprinting includes thermal nanoimprinting wherein the mold shape is transferred by heating and pressing, and UV nanoimprinting (photonanoimprinting) wherein an ultraviolet curing resin is cast onto the indentation surface of the mold, cured by light irradiation and then released from the mold. Recently, room temperature nanoimprinting methods have been developed which employ materials such as HSQ (Hydrogen Silsesquioxane).

Nanoimprint molds are produced by forming prescribed irregularity patterns on the surfaces of materials such as Si, quartz (SiO₂), SiC, Ta, glassy carbon and Ni. Such pattern formation is accomplished using electron beam lithography, synchrotron radiation lithography and EUV lithography, as well as electroforming techniques.

### SUMMARY OF THE INVENTION

Conventional lithography techniques can form patterns with very high resolutions of about 10 nm. However, usually only about 8-inch square areas can be worked with lithography apparatuses, and the area of a pattern that can be formed by a single light exposure is limited to about 20 cm square. In addition, finer patterns require much longer tracing times, tending to increase production cost.

Thus, fabrication of molds having indentation surfaces with large areas exceeding 20 cm square has not been technical or economically feasible when the molds are obtained utilizing lithography techniques. Joining of multiple molds has been considered when working of larger areas is required, but this leads to unavoidable inconveniences due to the resulting joints.

It is therefore an object of the present invention to provide a nanoimprint mold that can be easily produced without providing joints, even with large indentation surface areas for transfer. It is another object of the invention to provide a process for production of the nanoimprint mold.

As a result of much diligent effort directed toward solving the aforementioned problems, the present inventors have discovered that it is effective to employ a completely different method than the prior art, namely a method wherein a relief structure is formed by taking advantage of the nature of liquid crystal substances to undergo self-organization, and the invention has been completed upon this discovery.

Specifically, the invention relates to a nanoimprint mold that comprises a liquid crystal substance and has an indentation surface on which a relief structure is formed by orientation of the liquid crystal substance.

Since the nanoimprint mold of the invention has a relief structure formed on the surface based on the nature of the liquid crystal substance to self-organize, the area of the indentation surface is not limited as in lithography techniques, and it can be easily fabricated without joints even when the transfer indentation surface area is large.

In order to form the relief structure in an efficient and stable manner, the weight-average molecular weight of the liquid crystal substance is preferably at least 1000.

For the same reason, the liquid crystal substance is preferably oriented in such a manner that a helical structure is formed. More preferably, a chiral smectic C phase or chiral smectic CA phase formed by orientation of the liquid crystal substance is fixed.

The nanoimprint mold of the invention may also be a metal molded article having an indentation surface transferred from the relief structure of the aforementioned nanoimprint mold.

According to another aspect, the invention relates to a process for production of a nanoimprint mold. The production process of the invention comprises a step of forming a film containing a liquid crystal substance, and a step of orienting the liquid crystal substance so that a helical structure is formed, and fixing the orientation of the liquid crystal substance to form a relief structure on the surface of the film and thus obtain a film with an indentation surface as the nanoimprint mold.

The production process of the invention comprises a step of forming a film containing a liquid crystal substance, a step of orienting the liquid crystal substance so that a helical structure is formed, and fixing the orientation of the liquid crystal substance to form a relief structure on the surface of the film and thus obtain a film with an indentation surface, and a step of forming a metal molded article on the indentation surface of the film to obtain a metal molded article having an indentation surface formed by transfer from the relief structure, as the nanoimprint mold.

These processes allow easy production of nanoimprint molds with large transfer indentation surface areas even without providing joints.

The invention further relates to a method of working a material whereby a material is worked by transfer from the indentation surface of a nanoimprint mold according to the invention. According to the working method of the invention, it is possible to easily work a desired pattern into fine, large-sized working areas, while avoiding the inconveniences resulting from joints.

The invention provides a nanoimprint mold that can be easily produced without providing joints, even when the indentation surface area for transfer is large.

### BRIEF EXPLANATION OF THE DRAWINGS

FIG. 1 is an atomic force microscope photograph of the liquid crystal film surface produced in Example 1.

FIG. 2 is an optical photograph of the liquid crystal film surface produced in Example 1.

FIG. 3 is an atomic force microscope photograph of the liquid crystal film surface produced in Example 5.

### DESCRIPTION OF THE PREFERRED EMBODIMENTS

Preferred embodiments of the invention will now be described in detail. However, the present invention is not limited to the embodiment described below.

The nanoimprint mold of this embodiment has an indentation surface for transfer onto the surface of a material to be worked. The indentation surface has a relief structure formed by the liquid crystal substance composing the nanoimprint mold.

The pitch (length of one indentation cycle) on the relief structure forming the indentation surface of the mold may vary depending on the helical structure formed by the liquid crystal substance, but for most purposes it will be no greater than about 1000 nm. More specifically, the pitch of the relief structure is preferably 100-800 nm. The depth of the indentations in the relief structure is preferably 3-100 nm. The mold of this embodiment can be easily fabricated even with such fine patterns.

The liquid crystal substance composing the mold is a substance that can convert to a liquid crystal state by heating or the like. The liquid crystal forms an intermediate phase (mesophase) having both liquid and crystal properties. Specifically, liquid crystals are characterized by having both the flow properties of a liquid and the anisotropy of crystals. Liquid crystal substances known to exhibit a liquid crystal phase include “low molecular liquid crystal substances” and “macromolecular liquid crystal substances”. Since a characteristic order of molecular orientation is exhibited depending on the type of liquid crystal substance and the temperature and other environmental conditions, the molecular orientation can be utilized or controlled to allow application for various purposes. Liquid crystal substances therefore constitute a very large industrial field.

Liquid crystals are classified as nematic liquid crystals, smectic liquid crystals or discotic liquid crystals, based on their molecular shape or molecular arrangement. Smectic liquid crystals are liquid crystals wherein the liquid crystal substance having a rod-like mesogen forms a layer structure of one-dimensional crystals, or better termed a “two-dimensional liquid”.

Smectic liquid crystal phases may be classified as smectic A phase (SmA phase), smectic B phase (SmB phase), smectic C phase (SmC phase), smectic E phase (SmE), smectic F phase (SmF phase), smectic G phase (SmG phase), smectic H phase (SmH phase), smectic I phase (SmI phase), smectic J phase (SmJ phase), smectic K phase (SmK phase) or smectic L phase (SmL phase), depending on the order within the layer structure. In some of these smectic phases, the orientation vector of the rod-like mesogen of each layer in the phase is gradually twisted at a certain angle, such that an overall fixed helical structure with an orientation vector is exhibited. In a helical structure, the orientation of the molecules of the liquid crystal phase vary gradually with each layer, forming an overall rotated molecular orientation structure. As an example of a helical structure there may be mentioned a structure wherein the direction of the slope of the molecular long axis direction with respect to the normal direction to the layer in the smectic liquid crystal phase gradually rotates with each adjacent layer. The central axis of the helix in the helical structure is referred to as the “helical axis”. The distance of one helical turn in the helical axis direction is known as the “helical pitch”.

This is the type of helical structure usually formed in a chiral smectic phase. Examples of chiral smectic phases include phases having optical activity and exhibiting ferroelectricity, such as chiral smectic C phase (SmC* phase), chiral smectic I phase (SmI* phase) and chiral smectic F phase (SmF* phase), phases having optical activity and exhibiting antiferroelectricity such as chiral smectic CA phase (SmCA* phase), chiral smectic IA phase (SmIA* phase) and chiral smectic FA phase (SmFA* phase), and phases having optical activity and exhibiting ferrielectricity such as chiral smectic Cγ phase (SmCγ phase), chiral smectic Iγ phase (SmIγ phase) and chiral smectic Fγ phase (SmFγ phase).

Chirality is of course not necessary for formation of a helical structure, and smectic phases with helical structures can also be formed with achirality, as described in J. Mater. Chem., Vol. 6, p. 1231(1996) and J. Mater. Chem., Vol. 7, p. 1307(1997), for example.

In a nanoimprint mold, the liquid crystal phase with a helical structure as described above, formed by the orientation of the liquid crystal substance, is preferably fixed in a state with essentially no flow property. By fixing the orientation of the liquid crystal substance, the relief structure becomes fixed on the surface of the mold. A chiral smectic C phase or chiral smectic CA phase is preferably fixed from the viewpoint of the stability of the helical structure, adjustability of the helical pitch, easier synthesis of the liquid crystal substance composing the helical structure, and easier orientation due to lower viscosity in the liquid crystal state.

The nanoimprint mold of this embodiment is a molded article formed of a liquid crystal material which is a composition containing one or more liquid crystal substances. The nanoimprint mold is preferably a film (liquid crystal film) in order to facilitate formation of long molded articles with large areas.

A liquid crystal film used as the mold preferably has the helical axis bearing of the helical structure at a slope with respect to the main side of the film. The absolute value of the angle between the helical axis bearing and the main side of the film (hereinafter referred to as “slope angle”) will normally be 1-85 degrees, but is preferably 1-50 degrees and even more preferably 1-30 degrees. If the slope angle is less than 1 degree it may only be possible to obtain an effect essentially equivalent to a helical axis bearing oriented roughly parallel to the main side of the film, while if it is greater than 85 degrees it may only be possible to obtain an effect essentially equivalent to a bearing oriented roughly perpendicular to the main side of the film.

The helical axis bearing in the liquid crystal film may be uniform or variable within the film. Specifically, the mold may be composed of a film having a helical axis bearing with a fixed slope angle in the film thickness direction, or a film having a helical axis bearing that varies in the film thickness direction. That is, the slope angle in the film may be fixed regardless of the distance from the film surface, or the slope angle may differ depending on the distance from the film surface.

As modes of variation for a liquid crystal film in which the helical axis bearing varies in the film thickness direction, there may be mentioned continuous increase, continuous decrease, intermittent increase, intermittent decrease, variation including continuous increase and continuous decrease, or intermittent variation including increase and decrease. Intermittent variation includes cases where the slope angle ceases to vary at some point in the thickness direction, resulting in stepwise variation.

The orientation of the helical axis consists of oriented domains with microscopic orientation, and macroscopically it may be a multidomain phase with different directions for the helical axis, or a monodomain phase wherein all are aligned in the same direction. The sections that form the helical structure may be across the entire surface or only a portion of the film.

There are no particular restrictions on the helical pitch in the liquid crystal film used as the mold, but it is preferably 0.05-2 μm and more preferably 0.1-1 μm. The helical pitch may be constant throughout the film, but it may also differ in different locations of the film, or vary continuously. The helical pitch can be easily controlled by adjusting the orienting conditions such as temperature during production of the liquid crystal film (mold), or by adjusting the optical purity of the optically active sites or the mixing proportions of the optically active substances.

The liquid crystal substance used to form a molded article as the nanoimprint mold is one that can form a relief structure on the mold surface when its orientation is fixed. The liquid crystal substance preferably contains a rod-like mesogen group, having a smectic liquid crystal phase with a helical structure as described above in the phase series and having a fixable orientation.

The liquid crystal substance may be a low molecular liquid crystal substance or a macromolecular liquid crystal substance, or both types may be used. However, the liquid crystal substance is preferably a macromolecular liquid crystal substance with a weight-average molecular weight of 1000-1,000,000. If the weight-average molecular weight of the liquid crystal substance is less than 1000 it will tend to be difficult to adequately form a relief structure on the mold surface, and if it is greater than 1,000,000 it may be difficult to obtain a thin-film mold because of the radically reduced solubility.

The macromolecular liquid crystal substance may be a main-chain type macromolecular liquid crystal substance, a side-chain type macromolecular liquid crystal substance, or a combination of both.

Preferred for use as main-chain type macromolecular liquid crystal substances are one or more types of liquid crystal polymers selected from among polyester-based, polyamide-based, polycarbonate-based, polyimide-based, polyurethane-based, polybenzimidazole-based, polybenzoxazole-based, polybenzthiazole-based, polyazomethine-based, polyesteramide-based, polyester carbonate-based and polyesterimide-based substances.

As main-chain type macromolecular liquid crystal substances there are particularly preferred semi-aromatic polyester-based macromolecular liquid crystal substances having rod-like mesogen groups and bent chains selected from among polymethylene, polyethylene oxide and polysiloxane, wherein the chains are alternately bonded, and fully aromatic polyester-based macromolecular liquid crystal substances without bent chains.

Of these, polyester-based (liquid crystalline polyester) substances are preferred for forming a chiral smectic C phase because of their satisfactory orientation and relatively easy synthesis. As preferred examples of structural units for liquid crystalline polyesters there may be mentioned aromatic or aliphatic diol units, aromatic or aliphatic dicarboxylic acid units and aromatic or aliphatic hydroxycarboxylic acid units.

As side-chain type macromolecular liquid crystal substances there may be mentioned polymers with main chains having straight-chain or cyclic structures, such as polyacrylate-based, polymethacrylate-based, polyvinyl-based, polysiloxane-based, polyether-based, polymalonate-based and polyester-based polymers, with mesogen groups bonded as side chains. As side-chain type macromolecular liquid crystal substances there are preferred polymers having liquid crystallinity-imparting rod-like mesogen groups bonded via spacer groups which are bent chains on the main chain. Preferably, rod-like mesogen groups are present on both the main chain and side chains.

Examples of low molecular liquid crystal substances include Schiff base compounds, biphenyl-based compounds, terphenyl-based compounds, ester-based compounds, thio ester-based compounds, stilbene-based compounds, tolan-based compounds, azoxy-based compounds, azo-based compounds, phenylcyclohexane-based compounds, pyrimidine-based compounds, cyclohexylcyclohexane-based compounds, and combinations of the foregoing.

The macromolecular liquid crystal substance preferably has an optically active unit. Alternatively, the liquid crystal material may contain a chiral agent. Introduction of an optically active unit and/or chiral agent will facilitate formation of a smectic liquid crystal phase with the desired helical structure. For example, when a liquid crystal substance exhibiting a smectic C phase, smectic I phase or smectic F phase is used, introduction of an optically active unit or chiral agent can result in a chiral smectic phase that will more easily form a helical structure, such as a chiral smectic C phase, chiral smectic I phase, or chiral smectic F phase. The chiral agent content, the amount of optically active unit introduced, the optical purity and the temperature conditions during orientation may be appropriately adjusted to modify the helical pitch. Modification of the helical pitch allows control of the irregularity pattern pitch of the relief structure.

The helical structure may be either right helical or left helical. Appropriate selection of the chirality of the chiral agent or optically active unit used can yield a liquid crystal material that will form either a right helical or left helical structure.

Specific preferred examples of main-chain type macromolecular liquid crystal substances with optically active units include liquid crystal polymers comprising Unit 1 or Unit 2 represented by the following chemical formulas.

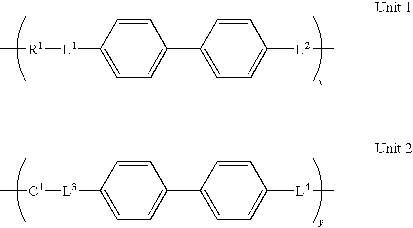

In Unit 1, R¹ is a C₁-C₂₄ straight-chain or branched alkyl group optionally containing an oxygen atom, and L¹ and L² each independently represent a single bond, —OOC—, COO, —O—, —OCOO—, —C≡C— or —C═C—.

In Unit 2, C¹ is a C₁-C₂₄ chiral hydrocarbon group optionally containing an oxygen atom, and L³ and L⁴ each independently represent a single bond, —OOC—, COO, —O—, —OCOO—, —C≡C— or —C═C—.

In the formulas, x and y are the proportions of each unit with respect to the total of Unit 1 and Unit 2 in the liquid crystal polymer, with the proviso that x is 0% or greater and y is 1% or greater. However, x is preferably 0-60%. Unit 1 and Unit 2 may be bonded in any order, and they may be bonded randomly or in blocks. Multiple instances of Unit 1 and Unit 2 forming the liquid crystal polymer may be the same or different. The weight-average molecular weight of the liquid crystal polymer is preferably 1000 or greater.

Specific preferred examples of side-chain type macromolecular liquid crystal substances with optically active units include liquid crystal polymers containing monomer units derived from monomers represented by the following chemical formula.

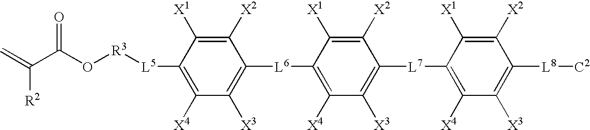

In this formula, R² represents hydrogen or a methyl group, R³ represents a C₁-C₂₄ alkyl group, L⁵, L⁶, L⁷ and L⁸ each independently represent a single bond, —OOC—, COO, —O—, —OCOO—, —C≡C— or —C═C—, C² represents a chiral C₁-C₂₄ hydrocarbon group optional containing an oxygen atom, X¹, X², X³ and X⁴ each independently represent hydrogen, a C₁-C₈ hydrocarbon optionally containing an oxygen atom, or a halogen atom, —NO₂, —NH₂, —CF₃ or —CN, and multiple X¹, X², X³ and X⁴ groups in the same molecule may be the same or different.

The liquid crystal material used to form the mold may contain components other than liquid crystal substances so long as the liquid crystal phase expression is not notably inhibited. For example, the liquid crystal material may contain various additives such as surfactants, polymerization initiators, polymerization inhibitors, sensitizing agents, stabilizers, catalysts, dichroic pigments, dyes, pigments, antioxidants, ultraviolet absorbers, adhesiveness improvers, hard coat agents and the like. The content of the liquid crystal substance in the liquid crystal material will normally be 30-100 wt %, and is preferably 50-100 wt % and even more preferably 70-100 wt %.

The liquid crystal substance in the mold may also be crosslinked with a crosslinking agent. Crosslinking of the liquid crystal substance can fix the orientation while improving the heat resistance of the mold. Examples of crosslinking agents include bisazide compounds and glycidyl methacrylate.

As explained above, the relief structure of the nanoimprint mold formed with the liquid crystal material is further transferred to another molded article, and used as the nanoimprint mold. For example, transfer to a metal molded article produces a mold with even more excellent resistance to pressure and heat. The metal molded article may be obtained, for example, by a method of forming a metal layer on the indentation surface of the liquid crystal film by electroforming. The metal is preferably nickel or copper from the viewpoint of conductivity and a good follow-up property for the shapes of fine indentations with sizes of several nm.

The liquid crystal film used as a nanoimprint mold may be produced, for example, by a process comprising a step of forming a liquid crystal material film containing a liquid crystal substance, and a step of orienting the liquid crystal substance so that a helical structure is formed, and fixing the orientation of the liquid crystal substance to form a relief structure on the surface of the film and thus obtain a film with an indentation surface as the nanoimprint mold.

More specifically, the following method (A) or (B) can yield a film (liquid crystal film) with a fixed orientation of the liquid crystal substance.
(A) A method wherein a film is formed of a liquid crystal material containing a macromolecular liquid crystal substance as the liquid crystal substance, and the film is heated to a temperature above the glass transition temperature of the macromolecular liquid crystal substance to orient the macromolecular liquid crystal substance so that a helical structure is formed, after which the film is cooled to a glassy state to fix the orientation of the macromolecular liquid crystal substance.
(B) A method wherein a film is formed of a liquid crystal material containing a polymerizable liquid crystal substance as the liquid crystal substance and heated to a temperature at which the liquid crystal substance exhibits a liquid crystal phase to orient the liquid crystal substance so that a helical structure is formed, and the liquid crystal substance is polymerized in that state, together with a polymerizable non-liquid crystal substance if necessary, to form a macromolecular liquid crystal substance and fix the orientation of the liquid crystal substance.

The macromolecular liquid crystal substance described above is preferably used in method (A). The polymerizable liquid crystal substance used in method (B) may be a liquid crystal substance with a polymerizable group that can be polymerized by ultraviolet light, visible light, an electron beam or heat. Examples of polymerizable groups include vinyl, acryl, methacryl, vinyl ether, cinnamoyl, allyl, acetylenyl, crotonyl, aziridinyl, epoxy, isocyanate, thioisocyanate, amino, hydroxyl, mercapto, carboxylic acid, acyl, halocarbonyl, aldehyde, sulfonic acid and silanol groups. Preferred among these are groups with double bonds, epoxy and aziridinyl, and more preferred are acryl, methacryl, vinyl, vinyl ether, epoxy and cinnamoyl groups.

The liquid crystal material film may be formed by a method of developing a liquid crystal material at the interface between a first phase selected from among gas, liquid and solid phases, and a second phase selected from among gas, liquid and solid phases. From the viewpoint of practicality of the obtained product and ease of production, the first phase and second phase are preferably solid phases, or the first phase is a solid phase and the second phase is a gas phase.

The gas phase may be composed of air or nitrogen, for example.

The liquid composing a liquid phase may be, for example, water, an organic solvent, a liquid metal, another liquid crystal, or a molten high molecular compound.

The solid composing a solid phase may be a base material selected from among plastic film bases, metal bases, glass bases, ceramic bases and semiconductor bases. Plastic base materials are formed from, for example, polyimides, polyamideimides, polyamides, polyetherimides, polyether ether ketone, polyether ketone, polyketone sulfide, polyethersulfone, polysulfone, polyphenylene sulfide, polyphenylene oxide, polyethylene terephthalate, polybutylene terephthalate, polyethylene naphthalate, polyacetal, polycarbonate, polyallylate, acrylic resin, methacryl resin, polyvinyl alcohol, polyethylene, polypropylene, poly-4-methylpentene-1 resin, cellulose-based plastics (triacetylcellulose and the like), epoxy resins and phenol resins, as well as polymer liquid crystals. A metal base material is formed from, for example, aluminum, iron or copper. A glass base material is formed from, for example, soda-lime glass, alkaline glass, non-alkaline glass, borosilicate glass, flint glass or quartz glass. A silicon wafer is an example of a semiconductor base material.

Another coating film may be formed on the base material, for example, an organic film such as a polyimide film, polyamide film or polyvinyl alcohol film, an oblique vapor deposition film of silicon oxide or the like, a transparent electrode such as ITO (indium-tin oxide) or the like, or a metal thin-film of gold, aluminum or copper formed by vapor deposition or sputtering. Different semiconductor elements such as amorphous silicon thin-film transistors (TFT) may also be formed on the base material.

The surface of the base material may be subjected to orientation treatment if necessary. When an oriented base material is used, the bearing of the helical axis in the obtained liquid crystal film may be set in a fixed direction prescribed by the direction of orientation of the base material. However, the bearing of the helical axis does not necessarily need to match the direction of orientation of the base material, and it may be slightly shifted from it. When a non-oriented base material is used, the obtained liquid crystal film will sometimes have a multidomain phase in which the helical axis bearing in each domain is random, but the desired effect can still be obtained in such cases.

There are no particular restrictions on the method of orienting the base material, and there may be mentioned rubbing methods, oblique vapor deposition methods, microgroove methods, stretched polymer membrane methods, LB (Langmuir-Blodgett) film methods, transfer methods and photoirradiation methods (photoisomerization, photopolymerization, photodecomposition and the like), and ablation methods. Rubbing methods and photoirradiation methods are particularly preferred from the viewpoint of facilitating production. In order for the helical axis to be at a slope with respect to the film surface, orientation treatment is preferably carried out to express a pretilt in the base material.

Even without using an oriented base material, the helical axis bearing in the obtained liquid crystal film can be oriented in a given direction by applying a magnetic field or electric field, shear stress, a current, stretching or a temperature gradient to the liquid crystal material developed between the interface.

The method of developing the liquid crystal material film at the interface is not particularly restricted and may be any of various known methods.

When a liquid crystal material is to be developed at the interface between two base materials, the liquid crystal material may be injected in a cell between the two opposing base materials, or the base material may be laminated on both sides of the liquid crystal material film.

When a liquid crystal material is to be developed at the interface between one base material and a gas phase, the liquid crystal material may be directly coated onto the base material, or a solution containing the liquid crystal material and a solvent dissolving it may be coated onto the base material. Development by coating of a solution is particularly preferred from the viewpoint of facilitating production.

The solvent may be selected as appropriate for the type of liquid crystal material and the composition. Common solvents used to dissolve liquid crystal materials include halogenated hydrocarbons such as chloroform, dichloromethane, carbon tetrachloride, dichloroethane, tetrachloroethane, trichloroethylene, tetrachloroethylene, chlorobenzene and orthodichlorobenzene, phenols such as phenol and parachlorophenol, aromatic hydrocarbons such as benzene, toluene, xylene, methoxybenzene and 1,2-dimethoxybenzene, alcohols such as isopropyl alcohol and tert-butyl alcohol, glycols such as glycerin, ethylene glycol and triethylene glycol, glycol ethers such as ethyleneglycol monomethyl ether, diethyleneglycol dimethyl ether, ethyl cellosolve and butyl cellosolve, acetone, methyl ethyl ketone, ethyl acetate, 2-pyrrolidone, N-methyl-2-pyrrolidone, pyridine, triethylamine, tetrahydrofuran, dimethylformamide, dimethylacetamide, dimethyl sulfoxide, acetonitrile, butyronitrile, carbon disulfide, and mixtures of the foregoing. A surfactant may also be added to the solution if necessary to adjust the surface tension and improve the coatability.

The concentration of the liquid crystal material in the solution may be appropriately adjusted depending on the type and solubility of the liquid crystal material used, and the film thickness of the liquid crystal film to be formed, but normally it will be in the range of 3-50 wt % and preferably 5-30 wt %.

The coating method is not particularly restricted, and spin coating, roll coating, printing, dip coating, curtain coating, Meyer bar coating, doctor blading, knife coating, die coating, gravure coating, microgravure coating, offset gravure coating, lip coating, spray coating or the like may be employed. After coating, the solvent may be removed if necessary and the liquid crystal material developed as a uniform layer on the base material.

There are no particular restrictions on the method of orienting the liquid crystal substance so as to form in the liquid crystal material film a smectic liquid crystal phase having a helical structure with the helical axis bearing at a slope with respect to the interface. For example, when the liquid crystal material has been developed at a temperature at which the liquid crystal material can form a smectic liquid crystal phase with a helical structure, the desired liquid crystal phase will sometimes be formed simultaneously with development. The liquid crystal substance can also be oriented by first superheating the developed liquid crystal material at a higher temperature than the smectic liquid crystal phase with the helical structure, to express a smectic A phase, chiral nematic phase or isotropic phase, for example, and then cooling it to a temperature at which the smectic liquid crystal phase with a helical structure is expressed. In any case, however, when the subsequent fixing step is carried out by method (A) described above, the orientation is at a temperature above the glass transition point of the liquid crystal material.

If necessary, the helical axis bearing may be controlled to a specific direction during orientation of the liquid crystal substance. Such control can be achieved by, for example, using one or more oriented base materials. When two base materials are used, either or both may be oriented.

Specifically, the helical axis bearing can be set in a specific direction by, for example, using a thick-film cell in which the helix of the liquid crystal material does not untwist, prepared using two rubbed polyimide glass bases, as a cell for injection of the aforementioned liquid crystal material. A specific direction can also be set for the helical axis bearing by laminating the liquid crystal material with two oriented plastic films. When such methods are used, the directions of orientation of the two base materials may be antiparallel (opposite orientation directions, achieved by using opposite rubbing directions for the rubbing treatment, for example) in order to obtain a structure in which the helical axes are uniformly inclined with respect to the base material, or they may be parallel (identical orientation directions) in order to obtain a structure in which the inclination of helical axes varies in the thickness direction of the liquid crystal film.

The liquid crystal material developed on the interface will sometimes have a fixed helical axis bearing even without using an oriented base material, or the helical axis bearing in the obtained liquid crystal film can be oriented in a given direction by applying a magnetic field or electric field, shear stress, a current, stretching or a temperature gradient to the liquid crystal material developed between the interface.

The orientation of the liquid crystal substance can be fixed by either method (A) or (B) described above.

In method (A), a liquid crystal material wherein the liquid crystal substance has been oriented so as to form a smectic liquid crystal phase having a helical structure with the helical axis bearing at a slope with respect to the plane of the film at a temperature above the glass transition temperature, may be cooled to a temperature at which the liquid crystal material becomes glassy, to fix the orientation of the liquid crystal substance in a glassy state so that the liquid crystal material does not become crystalline. The cooling means is not particularly restricted, and cooling sufficient for fixing can be achieved simply by removing the material from the heating atmosphere during the step of developing or orientation into an atmosphere at below the glass transition point, such as room temperature. Forced cooling by air-cooling, water-cooling or the like may also be carried out to increase the production efficiency.

In method (B), the liquid crystal material in which the liquid crystal substance has been oriented so as to form a smectic liquid crystal phase having a helical structure with the helical axis bearing at a slope with respect to the plane of the film, is polymerized while maintaining the same orientation. There are no particular restrictions on the polymerization method, and thermal polymerization or photopolymerization, radiation polymerization using γ-rays or the like, electron beam polymerization, or polycondensation or polyaddition reaction may be employed. Photopolymerization with visible light or ultraviolet light and electron beam polymerization are preferred for easier control of the reaction and more favorable production.

A metal molded article may be formed on the indentation surface of the obtained liquid crystal film to obtain a metal molded article having an indentation surface formed by transfer from the relief structure of the liquid crystal film. The metal molded article is preferably ablated from the liquid crystal film for use as the nanoimprint mold. The metal molded article may be obtained, for example, by a method of forming a metal layer by electroforming.

The surfaces of various types of materials can be worked by nanoimprinting, utilizing transfer from the indentation surface of the nanoimprint mold described above. The mold of this embodiment may be used for thermal nanoimprinting, photonanoimprinting and room temperature nanoimprinting. For example, a transfer member may be obtained comprising a roll and a film-shaped nanoimprint mold according to the embodiment described above wound around the peripheral surface of the roll, and the member used for continuous pressing against the surface of a long non-worked article, for continuous working of the surface of the long non-worked article with the nanoimprint mold.

The liquid crystal film of this embodiment may also be used to form an optical element. Specifically, the liquid crystal film may be used directly or with appropriate working if necessary, to obtain an optical element according to the invention. For example, when a liquid crystal film has been formed on a base material, the liquid crystal film may be released for use as an optical element, it may be left on the base material for use as an optical element, or the liquid crystal film may be laminated on a separate base material to obtain an optical element. The optical element may optionally have multiple layers of films with the same or different properties.

The separate base material for an optical element is not particularly restricted, and as examples there may be used plastic base materials composed of polyimide, polyamideimide, polyamide, polyetherimide, polyetheretherketone, polyetherketone, polyketone sulfide, polyethersulfone, polysulfone, polyphenylene sulfide, polyphenylene oxide, polyethylene terephthalate, polybutylene terephthalate, polyethylene naphthalate, polyacetal, polycarbonate, polyallylate, acrylic resins, methacryl resins, polyvinyl alcohol, polyethylene, polypropylene, poly-4-methylpentene-1 resin, cellulose-based plastics such as triacetylcellulose, epoxy resins, phenol resins and the like, or glass base materials, ceramic base materials, paper, metal sheets, and other optical elements such as polarizing plates, phase contrast panels, reflector plates and diffuser panels. The liquid crystal film of the invention may be used as an element with a fixed helical axis bearing without disturbance of the orientation, even when the oriented base material that has been used to set the helical axis bearing of the liquid crystal film in a fixed direction has been removed.

A protective layer, such as the transparent plastic film mentioned above, or a hard coat layer or the like, may also be provided if necessary on the liquid crystal film with fixed orientation, for improved surface protection, increased strength and improved environmental reliability.

### EXAMPLES

The present invention will now be explained in greater detail by examples. However, the present invention is not limited to the examples described below.

### Example 1

Isopropyl titanate was used as a catalyst for melt polymerization of dimethyl 4,4′-biphenylcarboxylate with 2-methoxy-1,4-butanediol and 1,6-hexanediol. The melt polymerization synthesized a liquid crystalline polymer as a copolymer comprising a bibenzonate skeleton and including unit (BB-6) represented by chemical formula (1) below and unit (BB-4(2-MeO)) represented by chemical formula (2) below. Because it is a copolymer, crystallization of the liquid crystalline polymer is effectively prevented.

The chirality C % of the 2-methoxy-1,4-butanediol, with an asymmetric carbon, used as a starting material for the melt polymerization, was determined by the following formula:

C %=(molar ratio of S enantiomer−molar ratio of R enantiomer)/(molar ratio of S enantiomer+molar ratio of R enantiomer)×100%

to be 100%.

The phase series of a copolymer with a weight-average molecular weight of 5.5×10³ obtained using X=40, Y=60, was determined to be as follows. Glassy state→chiral smectic C phase: 30° C. chiral smectic C phase→smectic A phase: 155° C. smectic A phase→isotropic phase: 220° C.

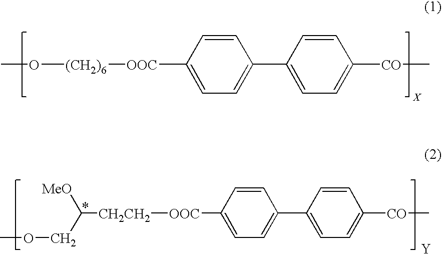

The tilt angle of the liquid crystalline polymer was calculated to be 20 degrees, by comparing the interlayer distance of the smectic A phase and chiral smectic C phase using an X-ray diffraction apparatus (RU200BH by Rigaku Corp., Cu Kα-rays).

The liquid crystalline polymer mass was heated to 180° C. and then slowly cooled to room temperature at a rate of −1° C. per minute, to fix the chiral smectic C phase. The liquid crystalline polymer mass having the fixed chiral smectic C phase was immersed in liquid nitrogen and cleaved by creating a notch with a knife, and a Pt/Pd thin-film (approximately 2 nm) was vapor deposited onto the cleaved surface by vacuum sputtering (E1030 Ion Sputter by Hitachi, Ltd.). The thin-film vapor deposited cleaved surface was observed with a field emission scanning electron microscope (FE-SEM, JSM-7500F by JASCO Corp.), revealing a lattice form in which multiple grooves were arranged in cycles of 155 nm-170 nm. When the cleaved surface was observed with an atomic force microscope (5500 by Agilent) in tapping mode (silicon cantilever, 75 kHz) in order to examine the surface form in greater detail, the lattice cycle was 172 nm-180 nm and the groove depth was 19 nm-21 nm.

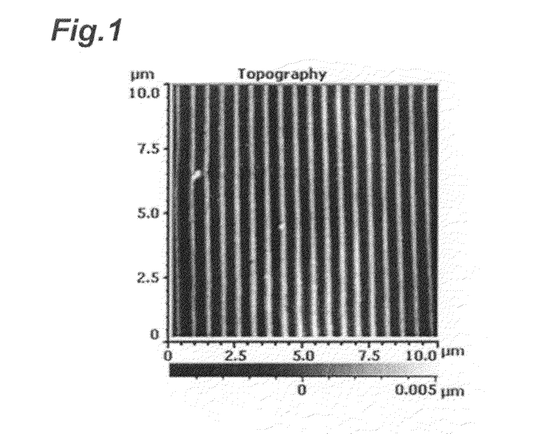

A 20 cm square rubbed imide glass was coated with a solution of the aforementioned liquid crystalline polymer in chloroform by spin coating, and the coated film was dried to obtain a liquid crystalline polymer thin-film (thickness: approximately 5 μm). When the thin-film was heated to 180° C., a uniformly oriented smectic A phase was formed. The thin-film was then slowly cooled to 120° C., and after holding it at 120° C. for 5 minutes, it was rapidly cooled to obtain a thin-film with a fixed chiral smectic C phase. Observation of the surface form at the air-side interface of the obtained thin-film with an atomic force microscope revealed that an indentation surface had been formed having a lattice with multiple grooves of 4 nm-5.5 nm depths arranged in cycles of 195 nm-215 nm (FIG. 1). The shallow depth compared to the cleaved surface obtained by splitting the polymer mass was attributed to the difference in surface tension between the polymer and air.

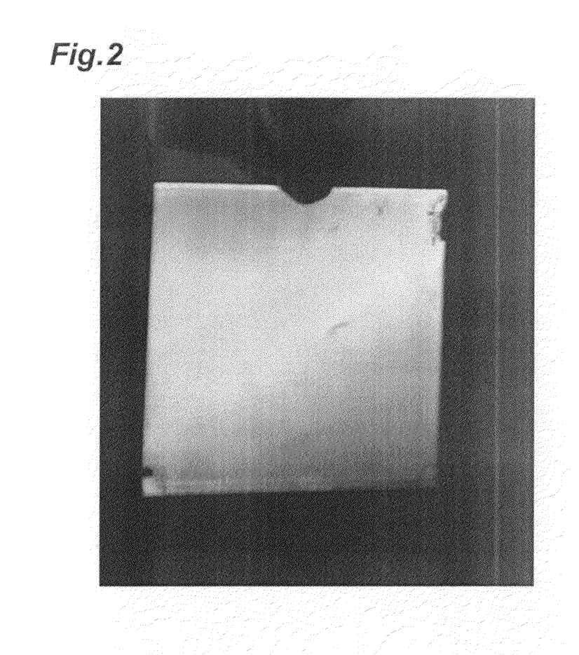

The obtained thin-film exhibited clear iridescence visible to the naked eye, indicating that it functions as a diffraction grating (FIG. 2). The obtained thin-film can be used as a nanoimprint mold having a lattice-shaped indentation surface with a cycle of about 200 nm.

### Example 2

A liquid crystalline polymer was obtained by the same procedure as Example 1, except that 2-methoxy-1,4-butanediol with a chirality of 80% was used. The weight-average molecular weight of the obtained liquid crystalline polymer was 6.0×10³. Observation of the cleaved surface of the liquid crystalline polymer mass with an atomic force microscope in the same manner as Example 1 revealed that an indentation surface had been formed having a lattice with a cycle of 210 nm-230 nm and a groove depth of 23 nm-28 nm.

Also, observation of the surface form at the air-side interface of a thin-film obtained in the same manner as Example 1 with an atomic force microscope revealed that an indentation surface had been formed having a lattice with a cycle of 235 nm-255 nm and a groove depth of 4.5 nm-6.5 nm.

### Example 3

A liquid crystalline polymer was obtained by the same procedure as Example 1, except that 2-methoxy-1,4-butanediol with a chirality of 50% was used. The weight-average molecular weight of the obtained liquid crystalline polymer was 4.4×10³. Observation of the cleaved surface of the liquid crystalline polymer mass with an atomic force microscope in the same manner as Example 1 revealed that an indentation surface had been formed having a lattice with a cycle of 280 nm-300 nm and a groove depth of 35 nm-45 nm.

Also, observation of the surface form at the air-side interface of a thin-film obtained in the same manner as Example 1 with an atomic force microscope revealed that an indentation surface had been formed having a lattice with a cycle of 315 nm-340 nm and a groove depth of 7.5 nm-9.5 nm.

### Example 4

A liquid crystalline polymer was obtained by the same procedure as Example 1, except that 2-methoxy-1,4-butanediol with a chirality of 35% was used. The weight-average molecular weight of the obtained liquid crystalline polymer was 4.1×10³. Observation of the cleaved surface of the liquid crystalline polymer mass with an atomic force microscope in the same manner as Example 1 revealed that an indentation surface had been formed having a lattice with a cycle of 580 nm-600 nm and a groove depth of 70 nm-80 nm.

Also, observation of the surface form at the air-side interface of a thin-film obtained in the same manner as Example 1 with an atomic force microscope revealed that an indentation surface had been formed having a lattice with a cycle of 550 nm-605 nm and a groove depth of 8.0 nm-11.5 nm.

### Comparative Example 1

A liquid crystalline polymer was obtained by the same procedure as Example 1, except that 2-methoxy-1,4-butanediol with a chirality of 0% was used. The weight-average molecular weight of the obtained liquid crystalline polymer was 6.1×10³. Observation of the cleaved surface of the liquid crystalline polymer mass with an atomic force microscope in the same manner as Example 1 revealed that it was smooth without the lattice shape observed in Examples 1-4. This confirmed that the twisted structure of the chiral smectic C phase was responsible for the surface relief structure.

### Example 5

A liquid crystalline polyester (intrinsic viscosity: 0.18 dL/g) was synthesized by melt polymerization of 200 mmol of dimethyl 4,4′-biphenyldicarboxylate, 120 mmol of 2-methyl-1,4-butanediol (enantiomeric excess, e.e.=90%) and 80 mmol of 1,6-hexanediol at 220° C. for 2 hours, using tetra-n-butyl orthotitanate as the catalyst.

A 6 wt % tetrachloroethane solution of this liquid crystalline polyester was prepared. The solution was spin-coated onto a rubbed glass substrate with a polyimide film and then heated to 60° C. on a hot plate to remove the solvent, thus obtaining a liquid crystalline polyester thin-film. This was then heat treated for 10 minutes in a thermostatic bath at 180° C. for orientation of the liquid crystalline polyester in a smectic A phase, after which the temperature was raised at 4° C./min to 120° C., as the temperature at which the liquid crystalline polyester became oriented in a chiral smectic C phase. Next, the liquid crystalline polyester thin-film was removed from the thermostatic bath and cooled to room temperature at which it forms a glassy state, thus fixing the orientation.

The obtained liquid crystalline polymer film had a chiral smectic C phase, with a helical structure, fixed in a glassy state and had a uniform film thickness (0.5 μm). Transmission electron microscope observation of the film cross-section revealed a helical pitch of about 0.5 μm for the helical structure formed in the film. The helical axis was inclined by about 12 degrees in the film thickness direction with respect to the base material surface, and the angle was constant in the film thickness direction. Also, the direction of the helical axis within the film plane was shifted by about 10 degrees counter-clockwise from the rubbing direction. The total light transmittance of the film was measured to be 95%.

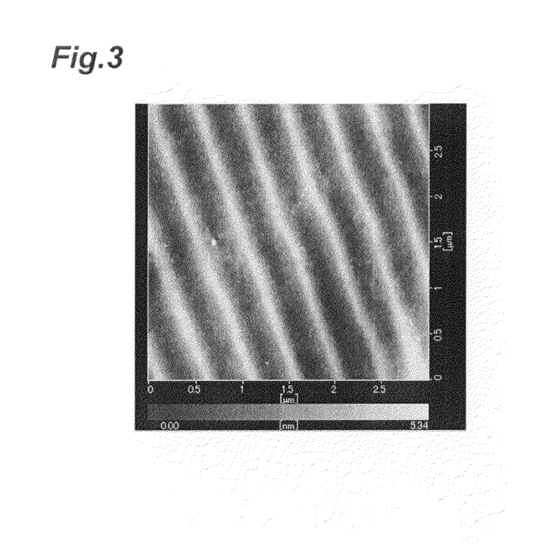

Also, observation of the surface form at the air-side interface of the film in the same manner as Example 1 with a scanning probe microscope revealed that an indentation surface had been formed having a lattice with a cycle of 445 nm-455 nm and a groove depth of 4 nm-5 nm (FIG. 3).

What is claimed is:

1. A nanoimprint mold comprising a liquid crystal substance and having an indentation surface on which a relief structure is formed by orientation of the liquid crystal substance.

2. A nanoimprint mold according to claim 1, wherein the weight-average molecular weight of the liquid crystal substance is 1000 or greater.

3. A nanoimprint mold according to claim 1, wherein the liquid crystal substance is oriented so as to form a helical structure.

4. A nanoimprint mold according to claim 3, wherein the chiral smectic C phase or chiral smectic CA phase formed by orientation of the liquid crystal substance is fixed.

5. A nanoimprint mold which is a metal molded article having an indentation surface transferred from the relief structure of a nanoimprint mold according to claim 1.

6. A process for production of a nanoimprint mold which comprises
a step of forming a film containing a liquid crystal substance, and
a step of orienting the liquid crystal substance so that a helical structure is formed, and fixing the orientation of the liquid crystal substance to form a relief structure on the surface of the film and thus obtain a film with an indentation surface as the nanoimprint mold.

7. A process for production of a nanoimprint mold which comprises
a step of forming a film containing a liquid crystal substance,
a step of orienting the liquid crystal substance so that a helical structure is formed, and fixing the orientation of the liquid crystal substance to form a relief structure on the surface of the film and thus obtain a film with an indentation surface, and
a step of forming a metal molded article on the indentation surface of the film to obtain a metal molded article having an indentation surface formed by transfer from the relief structure, as the nanoimprint mold.

8. A working method wherein a material is worked by transfer from the indentation surface of a nanoimprint mold according to claim 1.
